(19) United States
(12) Patent Application Publication
(10) Pub. No.: US 2017/0086426 A1
(43) Pub. Date: Mar. 30, 2017

(54) Scented Pet Toy

(71) Applicant: Glen Sica, Yorktown Heights, NY (US)

(72) Inventor: Glen Sica, Yorktown Heights, NY (US)

(21) Appl. No.: 15/280,687

(22) Filed: Sep. 29, 2016

Related U.S. Application Data
(60) Provisional application No. 62/234,254, filed on Sep. 29, 2015.

(51) Int. Cl. A01K 15/02

(52) U.S. Cl. CPC A01K 15/025

(57) ABSTRACT

The present invention generally relates to a scented pet toy infused with the primary chemical compounds found in the anal glands of dogs.

### BACKGROUND OF THE INVENTION

It is commonly known that many animals, particularly dogs and cats, have a much more highly advanced sense of smell than human beings. It is also commonly known that various scents can be used to provoke a desired reaction within animals. These general principals have long been used in the pet-toy industry to develop toys which utilize scent to achieve a desired effect.

By way of example, many scented pet toys are geared towards the desired effect of stimulation. This scent-induced stimulation is often achieved by means of artificially or naturally scenting a product to smell like food. For example, one commonly known dog toy is a rubber toy with an inner chamber for holding a common food (such as peanut butter) which stimulates play behavior. Similarly, many common cat toys incorporate an inner chamber for housing catnip—a common olfactory stimulant for cats. Such commonly available toys come in a great variety of shapes, sizes and materials. Importantly, the aromatic substances range from food products such as bacon, grilled pork ribs, cheddar cheese, pork roast, barbeque beef, salmon, chicken, hamburgers, and ice cream, to other substances such as vanilla and essential oils.

Other pet toys are geared towards the desired effect of having a calming or therapeutic influence on an animal. For example, the SENTRY® brand “Good Behavior Cuddlin' Companion Toy” (see, e.g., http://www.petsmart.com/dog/stress-anxiety-relief/sentry-good-behavior-trade-cuddlin-companion-beadtime-bear-dog-toy-zid36-26043/cat-36-catid-100061) discloses a pet toy and an applicator for dispensing a chemical which mimics a pheromone that mother dogs produce.

Other pet toys are geared towards education, i.e., teaching desired responses. For example, a dog toy resembling a bird that contains a bird-scented pack has been used to teach dogs to hunt, i.e., to stand fast and point in the direction of a bird that is scented nearby, and to then release on the sound of a gunshot and fetch the bird that has been shot. Another example is where the pet toy is in the shape of a skunk-like figure and directs an aromatic scent selectively from the tale via microcapsules that contain the scent of a skunk to teach the dog to stay away.

Other pet toys are geared towards entertainment, for example, pet toys with internal pouches containing play-stimulating responses.

Examples of prior art include the following patents. U.S. Pat. No. 5,037,343, dated Aug. 6, 1991, invented by Lorie K. Benites. U.S. Pat. No. 4,338,465, dated Jul. 6, 1982, invented by Arthur F. Isbell. U.S. Pat. No. 6,840,197, dated Jan. 11, 2005, invented by Timothy L. Trompke. U.S. Pat. No. 6,663,457 B2, dated Dec. 16, 2003, invented by Sharon A. Ritchey.

Many of these pet toys use a scent which is not natural to dogs (e.g., a food scent, bird scent or skunk scent) or which is not “ordinary” to an adult dog (e.g., a mother dog pheromone).

A final example of prior art comes from the work of Dr. Geore Preti in his paper Volatile Constituents of Dog (Canis familiaris) and Coyote (Canis latrans) Anal Sacs, Preti et al., J. Chem. Ecol., 1976, Vol. 2, No. 2, pp. 177-186 in which Dr. Preti discussed the chemical composition of Dog anal sac secretions.

### SUMMARY OF THE INVENTION

The present invention goes directly to the butt of the matter so to speak. It provides that irresistible and natural scent that attracts all dogs around the planet, the scent that originates from the anal glands of dogs.

The present invention is infused with the primary chemical compounds found in the anal glands of dogs. Dogs use these secretions as biological markers for signaling and, put colloquially, to “get to know one another”. Simply put, for dogs, these scents are like speaking with chemicals.

The present invention is not meant to replace a dog's unique way of communicating. It is intended to benefit a dog's owner by providing the dog with hours of irresistible sniff time. It may take away those embarrassing moments for owners with multiple dogs when their dogs cannot resist each other's backsides in front of family and friends.

One believed advantage of the present invention is the potential calming and/or therapeutic effect of the present invention on dogs. For example, many dogs suffer from separation anxiety or boredom when left alone. Pet owners often try to comfort their dogs by leaving behind toys or other objects. However, many dogs suffering from separation anxiety or boredom will destroy such toys or other objects—in part because the dog associates these articles with the absent owner. The present invention may comfort the dog by providing the scent of another dog, i.e., the illusion of a companion. Knowing that a close friend is “only a sniff away” may also help extend the life of the present invention compared with other pet toys. Many pet toys—particularly plush pet toys—can be quickly destroyed by dogs. However, it is believed that if a pet associates the present invention with a “friend dog” such a pet may be gentler with the present invention than other toys.

For humans tempted to sniff the present invention to check for themselves what a dog's backside actually smells like, they will be disappointed. Because the average dog's sense of smell is 10,000 to 100,000 times more sensitive than a human's sense of smell. In short, the humans will not smell a thing.

Because dogs have a far more acute sense of smell than humans, it is expected that most humans will be unable to detect the Scent Compound. In alternate embodiments, a “companion” scent could be added in addition to the Scent Compound where such “companion” scent is detectible by humans but does not interfere with a dog's interest in the underlying Scent Compound. Such a companion scent could be selected such that the rate of diminution of the “companion” scent is approximately the same as the rate of diminution of the Scent Compound. Thus, once a human is no longer able to smell the “companion” scent, he or she would be able to surmise that the Scent Compound needs to be refreshed or replaced. Similarly, in another alternate embodiment, a color-signaling compound could be used such that a particular portion of the scented pet toy changes colors whenever the Scent Compound needs to be refreshed or replaced. Finally, in an alternate embodiment, additional element(s) may be added to the Scent Compound to retard the rate of diminution of the Scent Compound when exposed to air.

There is no other invention (dog toy) like this on the current market. Coupled with its hallmark scent, the present invention's exterior is digitally imprinted with fun and appealing proprietary graphics. These graphics serve a dual purpose: (i) they attract the dog's attention; and (ii) they can be used to indicate where the plush toy has been scented. By way of example, a dog-shaped plush toy could be scented by means of an interior scented article comprising a polyester fiber stuffing infused with the Scent Compound which is positioned in the general area of the posterior (“butt”) of the toy (as defined below).

The preferred embodiment of the present invention is a stuffed and scented play toy for dogs. It measures approximately 7 inches wide and 9 inches long. The interior is filled with a polyester fiber stuffing. The exterior is made of durable polyester fabric and digitally imprinted with proprietary graphics. The exterior edges are sewn together with a durable polyester straight stitch. The sewn exterior edges are encased with a durable nylon binder and sewn again with a durable polyester straight stitch.

The scent used in the present invention is a synthesis of the chemical compounds found to be contained in the anal glands of dogs. These chemicals include one or more of the following: Ethanol, Trimethylamine, Acetic acid and Acetone, Isobutanal, Propionic acid, 2- and 3-Methylbutanal, Isobutyric acid, n-Butyric acid, 2-Methylbutyric acid and iso-valeric acid, n-Valeric acid, 4-Methylvaleric acid and 2-Methylvaleric acid, and 2-Piperidone (collectively, the “Scent Compound”). In the preferred embodiment, the Scent Compound comprises: Acetic acid, Propionic acid, Isobutyric acid, n-Butyric acid, Iso-valeric acid and 2-Methylbutyric acid, n-Valeric acid, 4-Methylvaleric acid and 2-Methylvaleric acid, and Trimethylamine.

The preferred embodiment of the present invention is designed to be scented in the general area of the “butt” of the toy using any one or more of three different methods. The first method is where the scent is added to the interior polyester fiber stuffing in the general area of the “butt” of the toy via a syringe. The second method is where the scent is integrated with the exterior polyester fabric in the general area of the “butt” of the toy using microencapsulation technology. The third method is where the scent is integrated with the digital printing process of the exterior graphics in the general area of the “butt” of the toy using microencapsulation technology.

The first method to scent the present invention is to have the chemical compounds in liquid form. A syringe is used to add the liquid to the interior polyester fiber stuffing. The scent is ever present and not required to be activated by the dog. The second method is to integrate the scent with the exterior polyester fabric using micro-sized bubbles, beads, capsules or particles that contain the scent. In one commercial embodiment of the present invention, the scent is activated when a dog picks up the dog toy. In various embodiments, this is done by a dog applying pressure (e.g., via a dog bite) or by a dog applying moisture (e.g., via dog saliva). The third method is to incorporate the scent into the digital printing process using a scented non-toxic varnish that is printed directly over the proprietary exterior graphics. The scent is activated by a dog's saliva when a dog picks up the present invention.

There has thus been outlined, rather broadly, the more important features of the invention in order that the detailed description thereof that follows may be better understood, and in order that the present contribution to the art may be better appreciated. There are, of course, additional features of the invention that will be described hereinafter and which will form the subject matter of the claims appended hereto. Those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1A is a front view of a plush toy appendage showing an interior crushable capsule in the appendage containing the Scent Compound.

FIG. 1B is a front view of a plush toy appendage showing an exterior pigmentation applied to the appendage comprising microencapsulated scent particles.

FIG. 2 is a front view of a hard chew toy having exterior microencapsulated scent particles.

FIG. 3A is a cutaway view of a plush toy article having an interior scented article that would be positioned in the general area of the “butt” of the toy.

FIG. 3B is a cutaway view of a plush toy article being refreshed using a chemical applicator.

FIG. 3C is a cutaway view of a plush toy article having an interior crushable capsule containing the Scent Compound that would be positioned in the general area of the “butt” of the toy.

FIG. 3D is a front view of a plush toy article having a partial exterior coating of microencapsulated scent particles that would be positioned in the general area of the “butt” of the toy.

FIG. 4A is an enlarged view of fabric showing microencapsulated scent particles.

FIG. 4B is an enlarged cutaway view of a single microencapsulated scent particle.

FIG. 5A is a representation of a quadruped-shaped plush toy having an interior crushable capsule containing the Scent Compound positioned in the general area of the “butt” of the toy.

FIG. 5B is a representation of a hominoid-shaped plush toy having an interior crushable capsule containing the Scent Compound positioned in the general area of the “butt” of the toy.

FIG. 6 is a representation of a quadruped-shaped plush toy inside of an oxygen barrier packaging where the plush toy has an interior scented article positioned in the general area of the “butt” of the toy.

FIG. 7 shows two versions of the commercial embodiment of the plush toy featuring an interior scented article positioned in the general area of the “butt” of the toy.

### DETAILED DESCRIPTION OF THE INVENTION

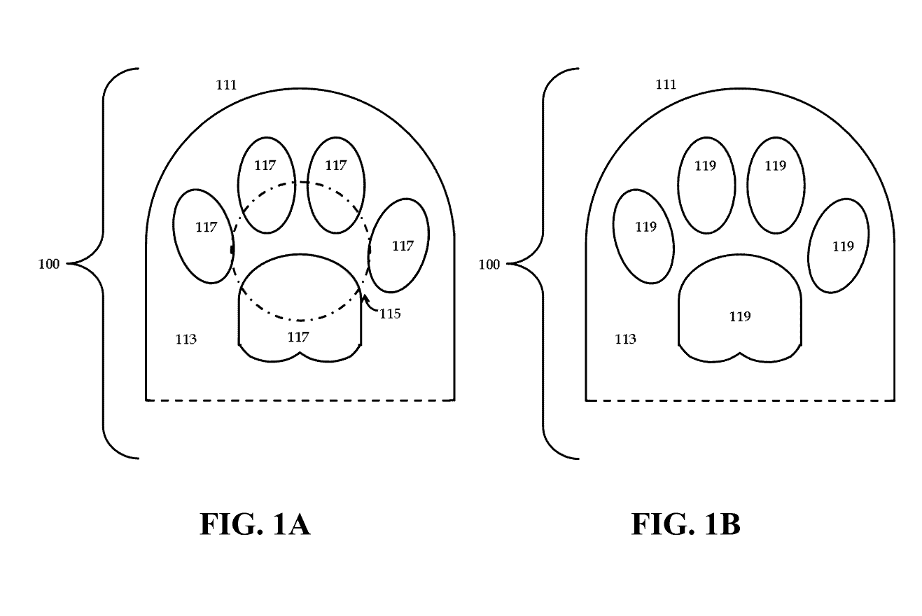

The present invention is directed towards a dog toy scented with a synthetic compound to mimic a canine's naturally occurring anal sac secretion. FIG. 1A shows a front view of a Plush Toy Appendage 100 having a Member 111 having an Outer Surface 113 made out of fabric. The fabric on this Outer Surface 113 is printed with proprietary Graphics 117. Such Graphics 117 may take many forms, and can be used to alert a customer to the location of an interior Scented Article 115 or a non-toxic, interior Crushable Capsule 115. FIG. 1A shows the Graphics 117 in an example “paw print” configuration.

FIG. 1B similarly shows a front view of a Plush Toy Appendage 100 having a Member 111 having an Outer Surface 113 made out of fabric. In FIG. 1B, however, the Scent Compound is printed directly onto the fabric using microencapsulated Scent Particles 119. In FIG. 1B, the Scent Particles 119 are shown mixed with pigmentation to help form the graphic design printed onto the Outer Surface 113.

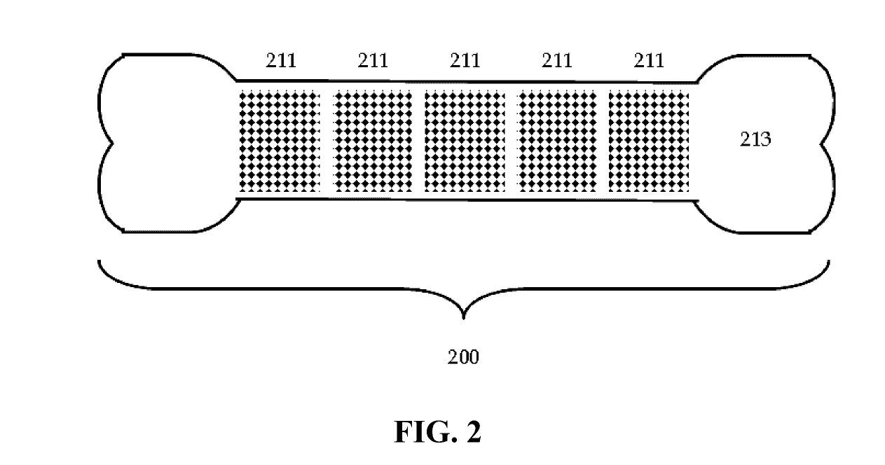

FIG. 2 shows a front view of a Hard Chew Toy 200 having an Exterior Surface 213 at least partially coated with microencapsulated Scent Particles 211. In FIG. 2, the Hard Chew Toy 200 is shown in the shape of a bone.

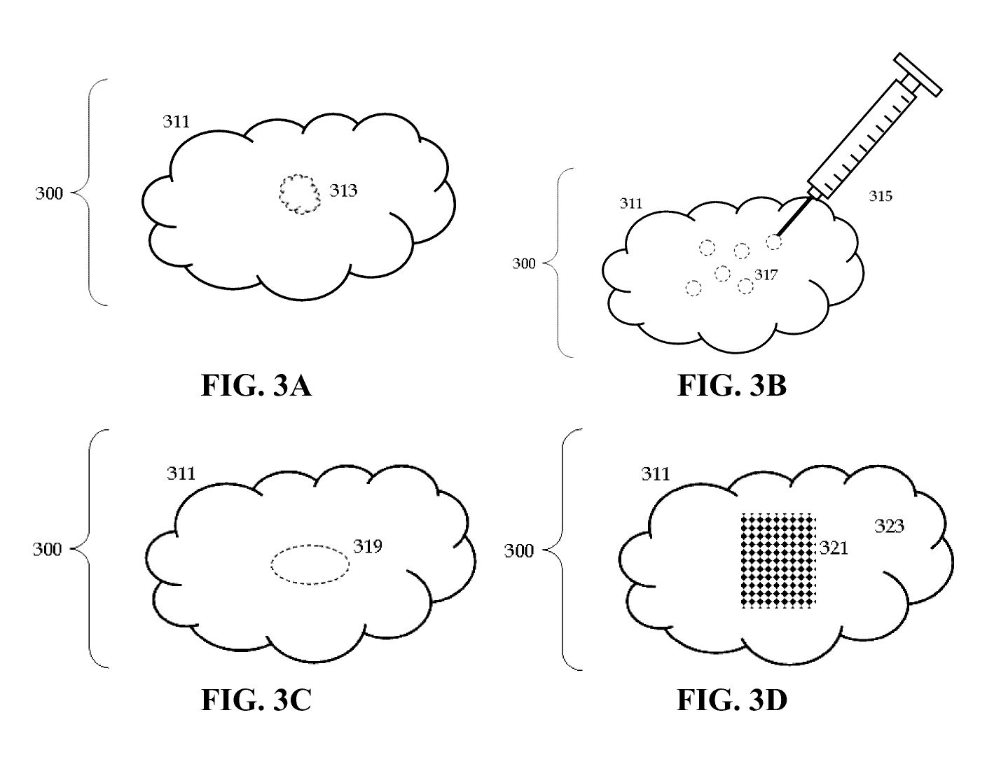

FIG. 3A through FIG. 3D show a Plush Toy 300 comprising a Plush Toy Body 311 and the five means for scenting the Plush Toy 300 disclosed in the present invention. In FIG. 3A, the Plush Toy 300 is scented by means of an Interior Scented Article 313. In the commercial embodiment, this Interior Scented Article 313 is a portion of the polyester fiber stuffing which has been infused with the Scent Compound. This Interior Scented Article 313 is then sewn directly into the Plush Toy Body 311 in the general area of the “butt” of the toy to prevent dislocation from the Plush Toy 300 or direct ingestion by a dog. In FIG. 3B, the Plush Toy 300 is scented by means of an Applicator 315 containing the Scent Compound. Using the Applicator 315, the Scent Compound can either be: (i) topically applied to the Plush Toy Body 311 in the general area of the “butt” of the toy; or (ii) injected directly into the interior stuffing of the Plush Toy Body 311 which is positioned in the general area of the “butt” of the toy. FIG. 3B shows a multitude of Droplets 317 containing the Scent Compound which have been injected directly into the interior stuffing of the Plush Toy Body 311. In FIG. 3C, the Plush Toy 300 is scented by means of a non-toxic, interior Crushable Capsule 319 (such as a commonly available gelatin capsule) containing the Scent Compound. A pet owner can activate the Plush Toy 300 shown in FIG. 3C by crushing the interior Crushable Capsule 319. Biting or “rough play” by a dog could similarly activate the Plush Toy 300 shown in FIG. 3C by crushing the interior Crushable Capsule 319. In one embodiment, the Plush Toy 300 could have an interior flap (secured by detachable fastening means such as VELCRO® brand hook and loop fasteners) for periodically removing a used Crushable Capsule 319 and replacing it with a replacement Crushable Capsule 319. FIG. 3D represents two possible means of scenting a Plush Toy 300 using microencapsulation technology. First, microencapsulation can be used to infuse the Outer Fabric 323 itself with Microencapsulated Scent Particles 321. Second, microencapsulation can be used during the exterior graphic printing process to coat the Outer Fabric 323 with Microencapsulated Scent Particles 321.

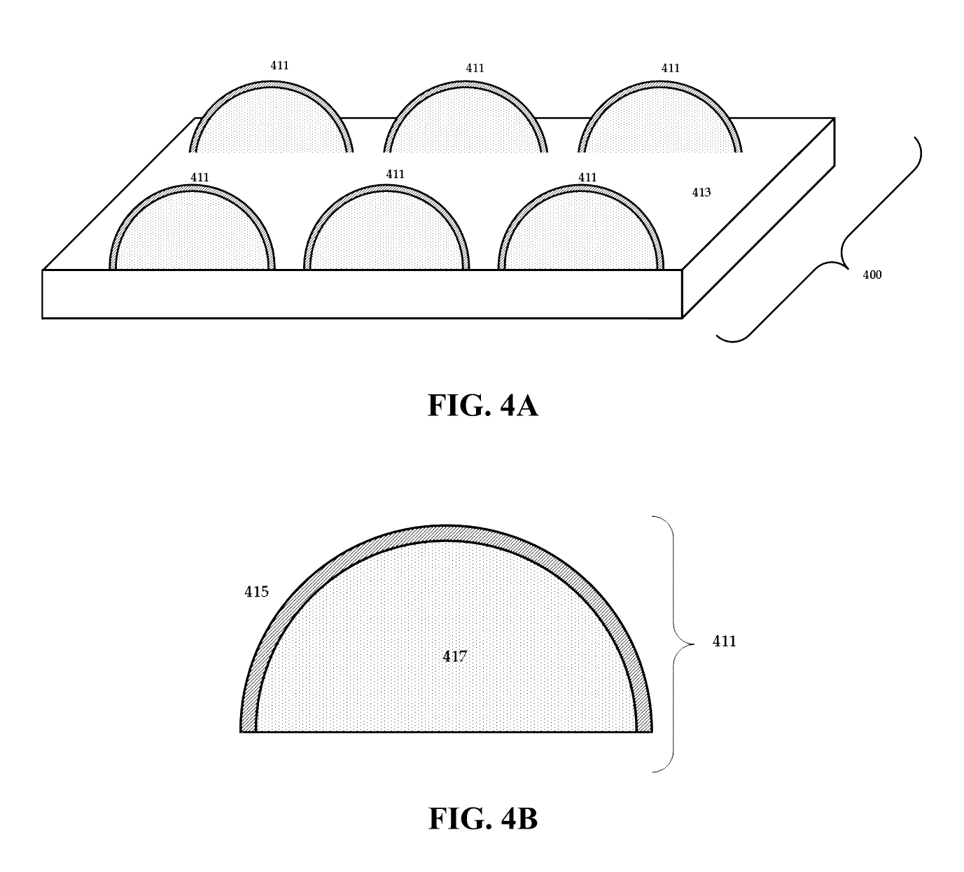

FIG. 4A is an enlarged view of a section of Printed Outer Fabric 400 comprising an Outer Fabric 413 with a coating of Microencapsulated Scent Particles 411 shown in cutaway. FIG. 4B is an enlarged cutaway view of a Microencapsulated Scent Particle 411 comprising an Encapsulation Matrix 415 and an Active Ingredient 417. In the preferred embodiment, the Active Ingredient 417 contains the Scent Compound. The Microencapsulated Scent Particles 411 may be constructed using a water soluble Encapsulation Matrix 415 such that the scent Compound will be released upon the application of moisture (e.g., through a dog's saliva).

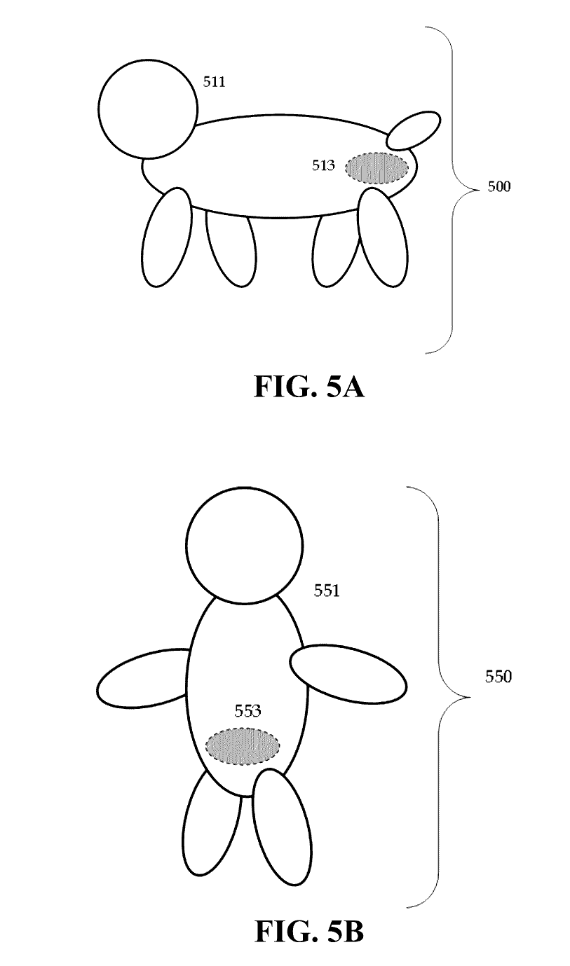

FIG. 5A shows a pictographic representation of a quadruped-shaped Plush Toy 500 having a Body 511 and an interior Crushable Capsule 513 containing the Scent Compound positioned in the general area of the “butt” of the Body 511. Similarly, FIG. 5B shows a pictographic representation of a hominoid-shaped Plush Toy 550 having a Body 551 and an interior Crushable Capsule 553 containing the Scent Compound positioned in the general area of the “butt” of the Body 551.

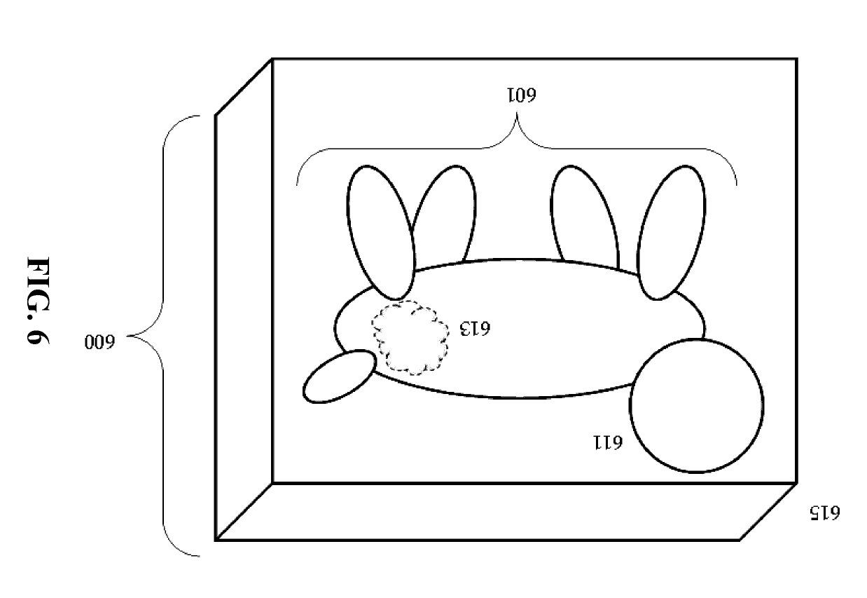

FIG. 6 shows a pictographic representation of a Packaged Plush Toy Assembly 600 having a quadruped-shaped Plush Toy 601 comprising a Body 611 and an Interior Scented Article 613 in the form of a portion of the polyester fiber stuffing inside the Body 611 which has been infused with the Scent Compound. This Interior Scented Article 613 is positioned in the general area of the “butt” of the Body 611. This Plush Toy 601 is packaged inside of an Air Barrier Package 615. Such an Air Barrier Package aids in maintaining the freshness of the Scent Compound which can otherwise diminish over time when exposed to air.

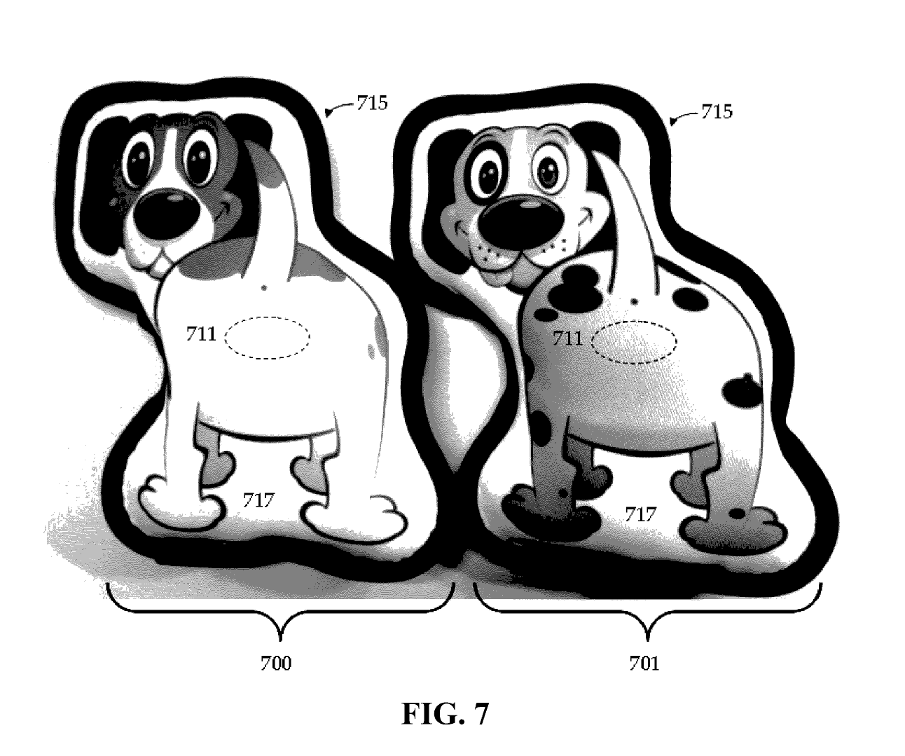

FIG. 7 shows two versions of the commercial embodiment of the plush toy. FIG. 7 shows two Envelopes 700 and 701 printed with various propriety Graphics 717. Embedded within each of the two Envelopes 700 and 701 is an Interior Scented Article 711 (depicted in dotted line format) positioned in the general area of the “butt” of the toy. The Envelopes 700 and 701 are stuffed using a polyester fiber stuffing. The Envelopes 700 and 701 are then sewn shut using a polyester straight stich along an Outer Seam 715.

Therefore, the foregoing is considered as illustrative only of the principles of the invention. Further, since numerous modification and changes will readily occur to those skilled in the art, it is not desired to limit the invention to the exact construction and operation shown and described, and accordingly, all suitable modifications and equivalents may be resorted to, falling within the scope of the invention.

I claim:

1. A scented play toy for dogs comprising a main member and a scent compound associated with the anal glands of dogs.

2. The scented play toy of claim #1, wherein said main member comprises a fiber stuffing interior and said fiber stuffing interior is infused with said scent compound.

3. The scented play toy of claim #1, wherein said main member comprises a fabric exterior and said scent compound is integrated with said fabric exterior using microencapsulation technology.

4. The scented play toy of claim #1, wherein said main member comprises a fabric exterior having digital graphics printed thereon, and said scent compound is integrated with said digital graphics during the digital printing process using microencapsulation technology.

5. The scented play toy of claim #1, wherein said scent compound comprises Acetic acid, Propionic acid, Isobutyric acid, n-Butyric acid, Iso-valeric acid and 2-Methylbutyric acid, n-Valeric acid, 4-Methylvaleric acid and 2-Methylvaleric acid, and Trimethylamine.

6. The scented play toy of claim #1, wherein said main member is in the shape of a dog and comprises a body, a head, four legs, a tail and a posterior “butt”, and wherein said scent compound emanates from said posterior “butt.”

7. The scented play toy of claim #6, wherein said body comprises a fiber stuffing interior and a fabric exterior, said interior having a first portion near said posterior “butt” and a second portion distal from said posterior “butt,” said first portion being infused with said scent compound.

8. The scented play toy of claim #7, wherein said scent compound in said first portion can be replenished when said scent compound has diminished.

9. The scented play toy of claim #6, wherein said body comprises a fiber stuffing interior and a fabric exterior, said exterior having a first portion near said posterior “butt” and a second portion distal from said posterior “butt,” said first portion having said scent compound integrated with said fabric using microencapsulation technology.

10. The scented play toy of claim #9, wherein said microencapsulated scent capsules can be released by application of pressure to said scent capsules.

11. The scented play toy of claim #9, wherein said microencapsulated scent capsules can be released by application of moisture in the form of dog saliva to said scent capsules.

12. The scented play toy of claim #9, wherein said scent capsules can be replenished by application of additional scent capsules.

13. The scented play toy of claim #6 wherein said body comprises a fiber stuffing interior and a fabric exterior having digital graphics printed thereon, said exterior having a first portion near said posterior “butt” and a second portion distal from said posterior “butt,” said scent compound is integrated with said digital graphics during the digital printing process using microencapsulation technology.

14. The scented play toy of claim #6 wherein said body comprises a fiber stuffing interior and a fabric exterior, said fabric exterior having edges that are sewn together with a durable polyester straight stitch, encased with a durable nylon binder and sewn again with a durable polyester straight stitch.

15. A scented play toy for dogs comprising a main member and a scent associated with the anal glands of dogs, comprising Acetic acid, Propionic acid, Isobutyric acid, n-Butyric acid, Iso-valeric acid and 2-Methylbutyric acid, n-Valeric acid, 4-Methylvaleric acid and 2-Methylvaleric acid, and Trimethylamine.

16. The scented play toy of claim #15, wherein said main member is in the shape of a dog and comprises a body, a head, four legs, a tail and a posterior “butt”, and wherein said scent emanates from said posterior “butt.”

17. The scented play toy of claim #16, wherein said body comprises a fiber stuffing interior and a fabric exterior, said interior having a first portion near said posterior “butt” and a second portion distal from said posterior “butt,” said first portion being infused with said scent.

18. The scented play toy of claim #16, wherein said body comprises a fiber stuffing interior and a fabric exterior, said exterior having a first portion near said posterior “butt” and a second portion distal from said posterior “butt,” said first portion having said scent integrated with said fabric using microencapsulation technology.

19. The scented play toy of claim #16, wherein said body comprises a fiber stuffing interior and a fabric exterior having digital graphics printed thereon, said exterior having a first portion near said posterior “butt” and a second portion distal from said posterior “butt,” said scent is integrated with said digital graphics during the digital printing process using microencapsulation technology.

20. A scented play toy for dogs comprising:
a. a main member in the shape of a dog, comprising a body, a head, four legs, a tail and a posterior “butt”;
b. a scent associated with the anal glands of dogs, comprising Acetic acid, Propionic acid, Isobutyric acid, n-Butyric acid, Iso-valeric acid and 2-Methylbutyric acid, n-Valeric acid, 4-Methylvaleric acid and 2-Methylvaleric acid, and Trimethylamine;
c. wherein said body comprises a fiber stuffing interior and a fabric exterior;
d. said interior having a first portion near said posterior “butt” and a second portion distal from said posterior “butt,” said first portion being infused with said scent;
e. said exterior having a first portion near said posterior “butt” and a second portion distal from said posterior “butt,” said first portion having said scent integrated with said fabric using microencapsulation technology;
f. said exterior having digital graphics printed thereon, said digital graphics having a first portion near said posterior “butt” and a second portion distal from said posterior “butt,” said scent is integrated with said digital graphics during the digital printing process using microencapsulation technology;
g. wherein said scent comprises first microencapsulated scent capsules which can be released by application of pressure to said first scent capsules and second microencapsulated scent capsules which can be released by application of moisture in the form of dog saliva to said second scent capsules; and
h. wherein said first and second scent capsules can be replenished when said scent has dissipated.
